(19) United States
(12) Patent Application Publication
(10) Pub. No.: US 2001/0037228 A1
(43) Pub. Date: Nov. 1, 2001

(54) System and method for using metadata to flexibly analyze data

(75) Inventors: Akihide Ito, Kanagawa (JP); Harushige Aono, Chiba (JP); Makoto Fukushima, Saitama (JP)

Correspondence Address: HOGAN & HARTSON LLP, IP GROUP, COLUMBIA SQUARE, 555 THIRTEENTH STREET, N.W., WASHINGTON, DC, 20004, US

(73) Assignee: IAF Consulting, Inc.

(21) Appl. No.: 09/840,860

(22) Filed: Apr. 25, 2001

Related U.S. Application Data
(60) Provisional application No. 60/202,181, filed on May 5, 2000.

(51) Int. Cl. G06F 17/60

(52) U.S. Cl. 705/7

(57) ABSTRACT

A system and method for using a metadata to flexibly analyze data. The system has a metadata that contains technical information and business model information and that exists independently of schemata of source and destination databases. The system also has a metadata management system. The metadata management system includes a mapping means capable of mapping schemata of the source databases to dimensions and measures in the metadata based on the technical information. It also has a modeling means capable of manipulating the business model information and a loading means capable of loading data stored in the source databases into the destination databases for analyses based on the technical information and the business model information stored in the metadata. The method uses source databases, destination databases, and a metadata. The method includes the step of maintaining the metadata that contains technical information and business model information and that exists independently of schemata of the source databases and of the destination databases. It also includes the step of mapping the schemata of the source databases to dimensions and measures in the metadata based on the technical information stored in the metadata and the step of manipulating business models stored in the metadata. Finally, the method includes the step of applying the technical information and the business model information stored in the metadata to load data in the source databases into the destination databases.

### CROSS REFERENCE TO RELATED APPLICATIONS

This application claims the benefit of U.S. Provisional Application No. 60/202,181, filed May 5, 2000.

### BACKGROUND OF THE INVENTION

1. Field of the Invention

The present invention relates to a system and method for using a metadata to flexibly analyze data. Specifically, the invention uses a metadata and a metadata management system to facilitate analyses of data stored in source databases by loading it to destination databases based on technical and business model information stored in the metadata.

2. Discussion of the Related Art

The recent growth of a data-warehouse market has given rise to a number of products that deal with a metadata. However, these products focus primarily on an operational management of a data warehouse. In other words, their functions are limited to extracting data from a source database, converting data, cleansing data, and/or controlling a data-loading schedule.

Lacking in these products is a capability to assist users in effectively analyzing data stored in a data warehouse so that users can use the data to make better strategic business decisions. Although some metadata-related products support simple analyses, such as displaying total sales for various product categories or geographic regions, they generally lack reusability and maintainability. This is partly due to the fact that a metadata in these products is connected with source and/or destination databases. For example, analysis or business models (“business models”) are frequently stored as a part of a destination database. Alternatively, business models may be defined in terms of a schema used by a source database.

The growth of the data-warehouse market has also coincided with an increased popularity of a multidimensional data analysis, which is often referred to as on-line analytical processing (“OLAP”). Prior to OLAP, relational database management system (“RDBMS”) software using a structured query language (“SQL”) interface was typically used with databases that comprised of traditional data types and that were easily structured into tables. However, RDBMS products have very limited abilities to consolidate, view, and analyze data. To overcome this limitation, a number of companies has introduced OLAP tools, which purportedly provide a user an ability to conduct more sophisticated analyses of data than RDBMS products.

Despite the popularity of OLAP, there are very few metadata-related tools that can handle multidimensional databases. A few products currently on the market offer a very limited analysis capability and often require a user to develop customized programs to conduct more sophisticated operations. Moreover, they tend to be data-specific in the sense that programs developed by the user are not transferable to another source or destination database. As a result, these tools generally lack reusability, lead to a high maintenance cost, and demand a lot of manpower to develop customized programs.

Thus, there is a great need in the art for a metadata-based data analysis system that allows a user to conduct sophisticated data analyses independently of schemata of source and destination databases and without a need for programming. Such system would allow the user to take a full advantage of information stored in data warehouse in a more economical and time-efficient manner.

### SUMMARY OF THE INVENTION

Accordingly, the present invention is directed to a system and method for using a metadata to flexibly analyze data that substantially obviates one or more of the problems due to limitations and disadvantages of the related art.

To achieve these and other advantages and in accordance with the purpose of the present invention, as embodied and broadly described, a system for using a metadata to flexibly analyze data stored in a plurality of source databases includes the metadata containing technical information and business model information. The metadata exists independently of schemata of the plurality of source databases and a plurality of destination databases. The system also includes a metadata management system with a mapping means, a modeling means, and a loading means. The mapping means is capable of mapping schemata of the plurality of source databases to dimensions and measures in the metadata based on the technical information. The modeling means is capable of manipulating the business model information. The loading means is capable of loading the data stored in the plurality of source databases into the plurality of destination databases for analyses based on the technical information and the business model information stored in the metadata.

In another aspect, the invention includes a method of flexibly analyzing data in a plurality of source databases by using a metadata. The method includes the step of maintaining the metadata. The metadata includes technical information and business model information and exists independently of schemata of the plurality of source databases and of a plurality of destination databases. The method also includes the step of mapping the schemata of the plurality of source databases to dimensions and measures in the metadata based on the technical information stored in the metadata. The method has the steps of manipulating the business model information stored in the metadata and applying the technical information and the business model information stored in the metadata to load data in the plurality of source databases into the plurality of destination databases for analyses.

In a further aspect, the invention includes an apparatus for executing commands to use a metadata to flexibly analyze data stored in a plurality of source databases. The apparatus includes a first set of computers with a data storage device having a plurality of source databases. It also has the metadata stored in a second set of computers. The metadata includes technical information and business model information and exists independently of schemata of the plurality of source databases and a plurality of destination databases. The apparatus further has a third set of computers with a data storage device containing the plurality of destination databases and a fourth set of computers for use by a user to analyze the data stored in the plurality of source databases using the metadata and a metadata management system. The metadata management system includes one or more computer programs that perform such functions as: (1) mapping the schemata of the plurality of source databases to dimensions and measures in the metadata based on the technical information; (2) manipulating the business model information; and (3) loading the data stored in the plurality of source databases into the plurality of destination databases for analyses based on the technical information and the business model information stored in the metadata. The first set of computers, the second set of computers, the third set of computers, and the fourth set of computers are interconnected by a network.

Finally, in another aspect, the invention includes an article of manufacture having a program storage medium readable by a computer and embodying one or more instructions executable by the computer to perform method steps for executing a command to use a metadata to flexibly analyze data in a plurality of source databases. The method includes the steps of maintaining the metadata and mapping the schemata of the plurality of source databases to dimensions and measures in the metadata based on technical information stored in the metadata. The metadata includes technical information and business model information and exists independently of schemata of the plurality of source databases and of a plurality of destination databases. The method also includes the steps of manipulating the business model information stored in the metadata and applying the technical information and the business model information stored in the metadata to load data in the plurality of source databases into the plurality of destination databases for analyses.

Additional features and advantages of the invention will be set forth in the description, which follows, and in part will be apparent from the description, or may be learned by practice of the invention. The objectives and other advantages of the invention will be realized and attained by the structure particularly pointed out in the written description and claims hereof as well as the appended drawings.

It is to be understood that both the foregoing general description and the following detailed description are exemplary and explanatory, and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention. In the drawings:

FIG. 1 is an overall system block diagram of a preferred embodiment of a system of the present invention;

FIG. 2 is a block diagram illustrating one example of the conceptual structure of mapping between a metadata and source databases of a preferred embodiment of the present invention;

FIG. 3 is an overall system block diagram illustrating an exemplary hardware environment used to implement a preferred embodiment of the present invention;

FIG. 4 is a block diagram illustrating use of a virtual member to modify a hierarchical tree structure according to a preferred embodiment of the present invention; and

FIG. 5 is a flow chart illustrating exemplary steps performed to use a metadata to flexibly analyze data stored in source databases according to a preferred embodiment of the present invention.

### DETAILED DESCRIPTION OF THE PREFERRED EMBODIMENTS

Reference will now be made in detail to the preferred embodiments of the present invention, examples of which are illustrated in the accompanying drawings.

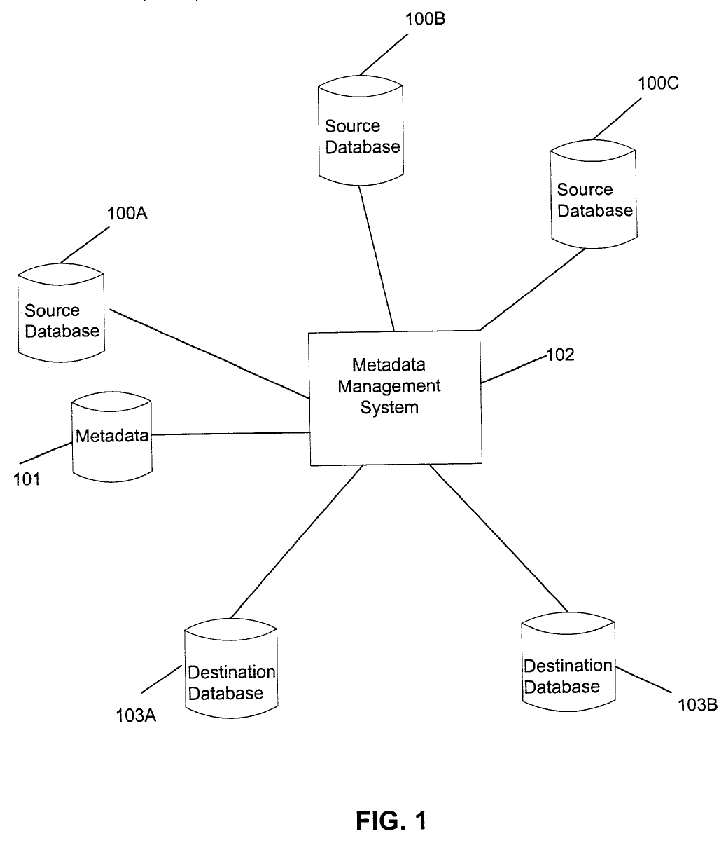

With reference to FIG. 1, an overall system block diagram of a preferred embodiment of the present invention includes source databases 100A, 100B, and 100C, a metadata 101, a metadata management system 102, and destination databases 103A and 103B.

The source databases 100A, 100B, and 100C contain data to be analyzed using the metadata 101 and the metadata management system 102. Although FIG. 1 shows three databases, there is no restriction as to a number of source databases. Moreover, source databases do not need to reside in a memory of one computer. Nor do they need to reside within a memory of a computer or computers containing the metadata 101, the metadata management system 102, and/or the destination databases 103A and 103B. They may reside in memories of a plurality of computers corrected by a network. However, the source databases 100A, 100B, and 100C need to be accessible from a computer or computers containing the metadata management system 102 via a network. Similarly, the destination databases 103A and 103B need to be accessible to the metadata management system 102.

The source databases 100A, 10B, and 100C can be of many different types. Specifically, they may be relational databases, flat files, spreadsheets, and files created by third-party software such as Enterprise Resource Planning software. Moreover, it is possible to have different types of source databases. In other words, some of data to be analyzed may be stored in relational databases, while the rest of the data may be stored in spreadsheets.

The destination databases 103A and 103B are used to analyze data obtained from the source databases 100A, 100B, and 100C using the metadata 101 and the metadata management system 102. Like the source databases 100A, 100B, and 100C, there is no restriction as to a number of destination databases. The destination databases 103A and 103B may be relational databases or multi-dimensional databases. They may also be spreadsheets or flat files. In other words, the present invention supports many different types of source and destination databases.

The destination databases 103A and 103B need not reside in a memory of one computer or in a memory of a computer which contains the source databases 100A, 100B, and 100C, the metadata 101, and/or the metadata management system 102, as long as they are accessible via a network from a computer or computers having the metadata management system 102. In other words, the present invention does not depend on hardware architecture used to implement the invention.

The metadata 101 may contain technical information and business model information. Technical information may include information needed to access the source databases 100A, 100B, and 100C and the destination databases 103A and 103B, and information necessary to map schemata of the source databases to dimensions and measures in the metadata 101. It may also include information related to programming languages such as SQL and SPL and display related information. Business model information may include information needed to construct business models. For example, in analyzing sale data, one may choose to consider time, location, and products.

Users may define dimensions in the metadata based on business terminology—that is, terminology commonly used in a field to which data in source databases relates. For example, if source databases contain corporate financial data, then their data may be defined using business and/or financial terms. In other words, dimensions and measures allow a user to conduct data analyses by using “familiar” terms, even when a source database uses “unfamiliar” names for data.

Each dimension may have one or more sub-dimensions associated with it. Like dimensions, sub-dimensions may also be defined using terminology of a relevant area.

There may be least two types of dimensions—master dimensions and ranking dimensions. Master dimensions may be used, for example, for SQL summations and for directly accessing dimensions within source databases. They may also be used when doing summations based on coded items in a master table in a source database. Ranking dimensions may be used for summations based on rules not found in a master table in a source database. Ranking dimensions allow users to rank a fact column in a source database according to their values without using flags.

Users may also specify mapping information necessary to associate a dimension to one or more specific data or data columns in a source database. For example, users may specify a source database and give information necessary to access it. If a source database is a relational database, users may specify an appropriate master table, a key column to be joined with a fact table, and a name column that corresponds to a business term associated with the dimension. Similarly, for a sub-dimension, users may specify a parent dimension, a key column to be joined, and a name column that corresponds to a business term associated with the sub-dimension. If a source database is a flat file or a spreadsheet, users need specify information necessary to map a dimension to an appropriate section or column of such files.

Users may also define measures based on business terminology. Measures are used to represent a sum of a fact column in a source database or to count a fact column in a source database. The former is of summation type and the latter is of count type.

Users may also map measures to an appropriate portion of a source database. If a source database is a relational database, for example, a measure may be defined by specifying a source database and its access information, an appropriate fact table within the source database, and a column within the fact table to be associated with the measure.

It is also possible to map one or more dimensions defined within the metadata 101 to one or more measures. In other words, given a set of dimensions, many different measures may be defined. For example, for dimensions containing data regarding a product sale, measures may be a total sale, a number of products sold, and/or a profit. By using measures, a user can analyze the same set of dimensions from various viewpoints.

Further, users may also specify specific programs used to process data in a source database. Such programs may be stored in the metadata 101 and thus made accessible to the metadata management system 102.

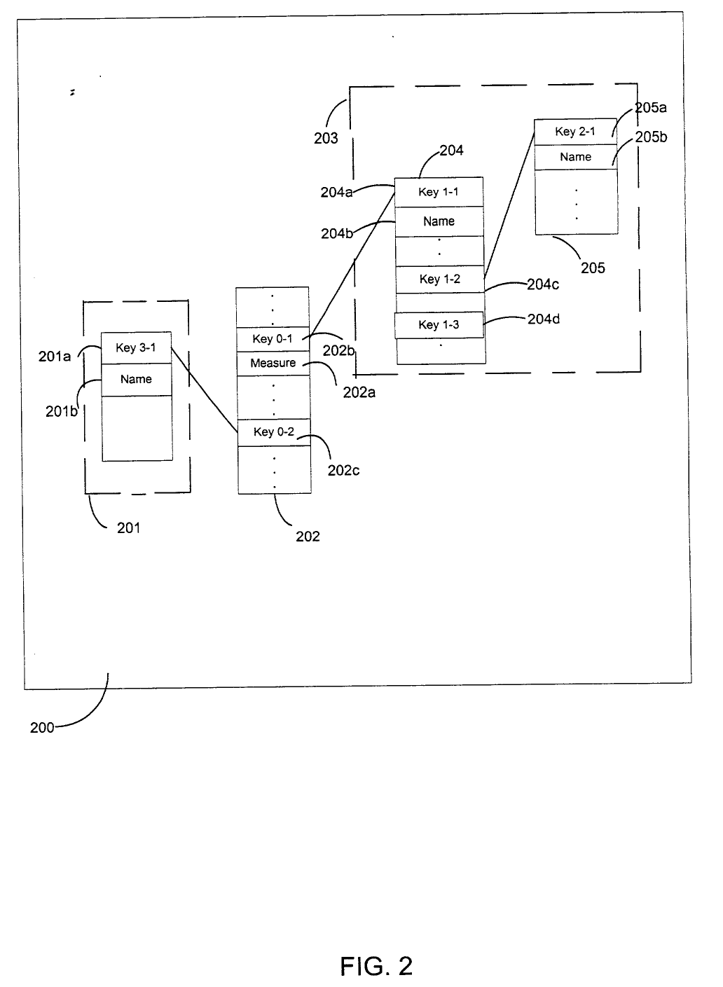

FIG. 2 is a block diagram illustrating one example of a conceptual structure 200 of a mapping between a metadata and a source database. A master dimension 201 has Key3-1 201a and Name 201b. Key3-1 201a is mapped to Key0-2 202c in a fact table 202. The fact table 202 has Key0-l 202b, Measure 202a, and Key0-2 202c. A dimensional hierarchy 203 includes a master dimension 204 and a master sub-dimension 205. The master dimension 204 includes Key1-1 204a, Name 204b, and Key1-2 204c. Key1-2 204c of the master dimension 204 is connected to Key2-1 205a of the master sub-dimension 205. The master sub-dimension 205 includes Key2-1 205a and Name 205b.

It is also possible to join two keys within one master dimension. For example, the master dimension 204 may include another key, Key1-3 204d, to which Key1-2 204c is mapped.

Referring back to FIG. 1, the technical information in the metadata 101 may also include information regarding a hierarchical tree structure of dimensions. Users may define a hierarchical tree structure using dimensions, by constructing a tree structure whose nodes correspond to dimensions that exist within the metadata.

In addition, the metadata may allow users to specify information regarding a time axis to be used in analyzing data stored in the source databases 100A, 100B, and 100C. Data may be analyzed on a yearly, half-yearly, quarterly, monthly, or daily basis. It may also be analyzed on an hourly basis and even more frequently by defining a time axis unit based on minutes or even on seconds. The metadata may contain a number of pre-defined time axes, time units, and formats used to express time. As a result, users may specify a time axis by simply selecting from those provided in the metadata. In addition, users are allowed to specify a starting date and/or time and an ending date and/or time. The metadata may include one or more time axes defined by users.

Business model information in the metadata 102 comprises of business models. Business models may be defined in terms of standard business terminology associated with dimensions, sub-dimensions, and measures. The metadata management system 102 may support a number of business models as templates and/or built-in functions. In addition, users may be allowed to create business models on their own, by attaching one or more programs, for example.

Within the metadata 101, dimensions, measures, and business models are treated as objects. This object-oriented approach allows users to create hierarchical tree structures and new business models in an object-oriented manner, by reusing preexisting dimensions, measures, and business models. For example, users can build a new business model by merely combining pre-existing business models.

The metadata 101 may also contain information necessary to load information into the destination databases 103A and 103B. Such information may include information regarding a server used to manage the destination databases 103A and 103B and programming languages supported by the server and/or by the destination databases 103A and 103B.

Unlike prior art, the metadata 101 exists independently of schemata of source databases 100A, 100B, and 100C and destination databases 103A and 103B. In other words, the metadata 101 can be reused even when schemata or other attributes of source and/or destination databases change, by merely updating mapping information. For an entirely new source data, one may simply enter mapping information so that the metadata management system 102 can access it. Similarly, a change in schemata and/or attributes of pre-mapped source and/or destination databases may not require a user to create an entirely new metadata. Rather, a user may simply update appropriate mapping information in the metadata.

The metadata management system 102 uses information stored in the metadata 101 to flexibly analyze data stored in the source databases 100A, 100B, and 100C. Typically, the matadata management system 102 comprises a collection of programs. The metadata management system 102 needs to be able to access the source databases 100A, 100B, and 100C the metadata 101, and the destination databases 103A and 103B.

Operations performed by the metadata management system 102 may include mapping schemata of the source databases 100A, 100B, and 100C based on the technical information stored in the metadata 101, assisting a user to manipulate the business model information, and loading data stored in the source databases 100A, 100B, and 100C into the destination databases 103A and 103B based on the technical information and the business model information stored in the metadata 101. The user may manipulate the business model information by constructing a new business model, storing the new business model constructed by the user, or modifying an existing business model stored in the metadata. The loading step may be performed automatically without requiring much user intervention.

The metadata management system 102 may also have a capability to generate codes necessary to perform its operations. For example, when loading data into the destination databases 103A and 103B, the metadata management system 102 may generate codes to extract data stored in the source databases 100A, 100B, and 100C. It may further generate codes to aggregate and/or load the extracted data into the destination databases 103A and 103B.

Furthermore, the metadata management system 102 may also have a capability to update the destination databases 103A and 103B and/or a capability to aggregate data loaded into the destination databases 103A and 103B based on the technical information and the business model information in the metadata 101. The updating capability may make sure that data in the destination databases 103A and 103B is consistent with data in the source databases 100A, 100B, and 100C and the metadata 101. The metadata management system 102 may be programmed to allow a user to schedule a periodic update or conduct an event-driven update, such as automatic update upon changes in the metadata 101. The aggregation capability may include a capability to automatically generate codes to operate upon data loaded into the destination databases 103A and 103B. It may also use one or more programs stored in the metadata and/or specified by a user.

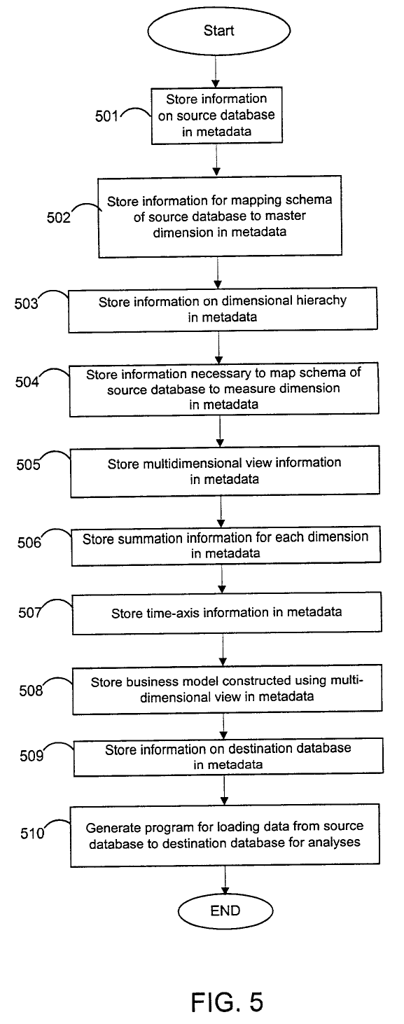

FIG. 5 is a flow chart illustrating exemplary steps performed using one preferred embodiment of the present invention. While FIG. 5 shows ten separate steps, they are not necessarily required. For example, once a user stores information necessary to access a source database and to map schemata of the source database to dimensions in metadata, the user may reuse the information previously stored in the metadata. In other words, the user may decide to perform only steps 505 through 509. Nor do these steps need to be performed in the order indicated. For example, after constructing a multidimensional view at step 505, the user may define an additional master dimension. Moreover, the steps shown in FIG. 5 assume that destination databases support multi-dimensional analyses. Steps 505 and 508, for example, are specific to multi-dimensional destination databases. As a result, they may not apply to destination databases without a multi-dimensional analysis capability.

At step 501, a user uses a metadata management system to store information on a source database in a metadata. Such information may include a name of the source database, a type of the source database, an operating system running on a server in which the source database is stored. It may also include a username and a password for accessing the source database. In addition, the user may also enter information necessary to access a server used to perform data analyses over a network. For example, when using FTP, the user may enter a server name, a user name, a password, a FTP root directory, and a directory connected to the FTP root directory to be used to temporarily store results of summations and other operations.

At step 502, the user uses the metadata management system to store information necessary to map schemata of the source database to master dimensions. At step 503, information necessary to construct a hierarchical tree structure using master dimensions are stored in the metadata. A dimensional hierarchy may also be created by creating sub-dimensions or by creating a tree-like structure using existing dimensions.

At step 504, the user stores information necessary to map schemata of the source database to measures. At step 505, the user constructs a multidimensional view, using measures and dimensions constructed at steps 502 and 504 and store it in the metadata. At step 506, the user stores summation information for dimensions in the metadata.

At step 507, the user stores time axis information in the metadata. As described above, the metadata may support a number of different time axes. As a result, all that the user needs to do at this step may be to select one of the pre-existing time axes or to modify it. At step 508, the user constructs business models based on the multidimensional view and stores it in the metadata. At step 509, the user stores information necessary to access the destination database in the metadata such as information necessary to log-on to a server where the destination database resides.

Finally, at step 510, the user uses the metadata management system to generate a program or programs necessary to load data from the source database to the destination database using the information stored in the metadata at steps 501 through 509. If a destination database does not exist, it may be created prior to the loading step. Otherwise, the loading step may use an existing destination database. Further, the user may elect to use a program or programs stored in the metadata, for example, to load data.

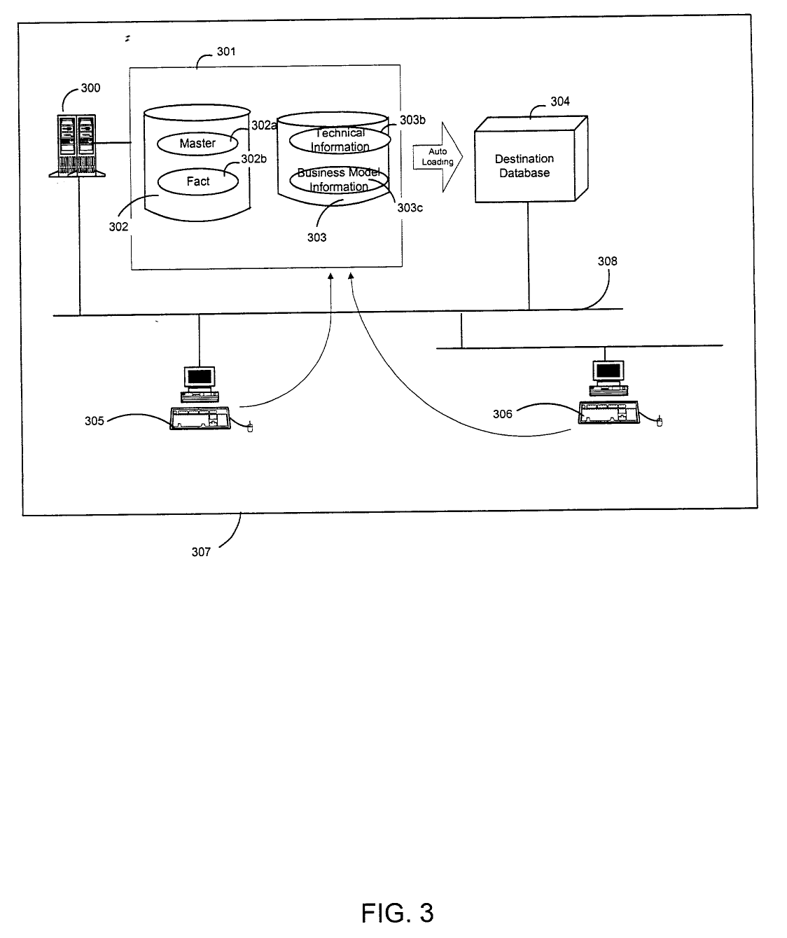

FIG. 3 is an overall system block diagram illustrating an exemplary hardware environment used to implement a preferred embodiment of the present invention. In this example, a metadata 303 and a source database 302 resides in a memory 301 of a server 300. The source database 302 includes master tables 302a and fact tables 302b. Some of those skilled in the art may refer to master tables as dimensional tables instead. In this application, the term master table is used to distinguish it from dimensions used in the metadata. The metadata 303 includes technical information 303a and business model information 303b.

The server 300, a destination database 304, and computers 305 and 306 are interconnected by a network 308. The computers 305 and 306 are used by users to analyze data stored in the source database 302 based on the metadata 303. The destination database 304 may reside in a memory of the server 300 or a different server. The destination database 304 is connected to the network 308.

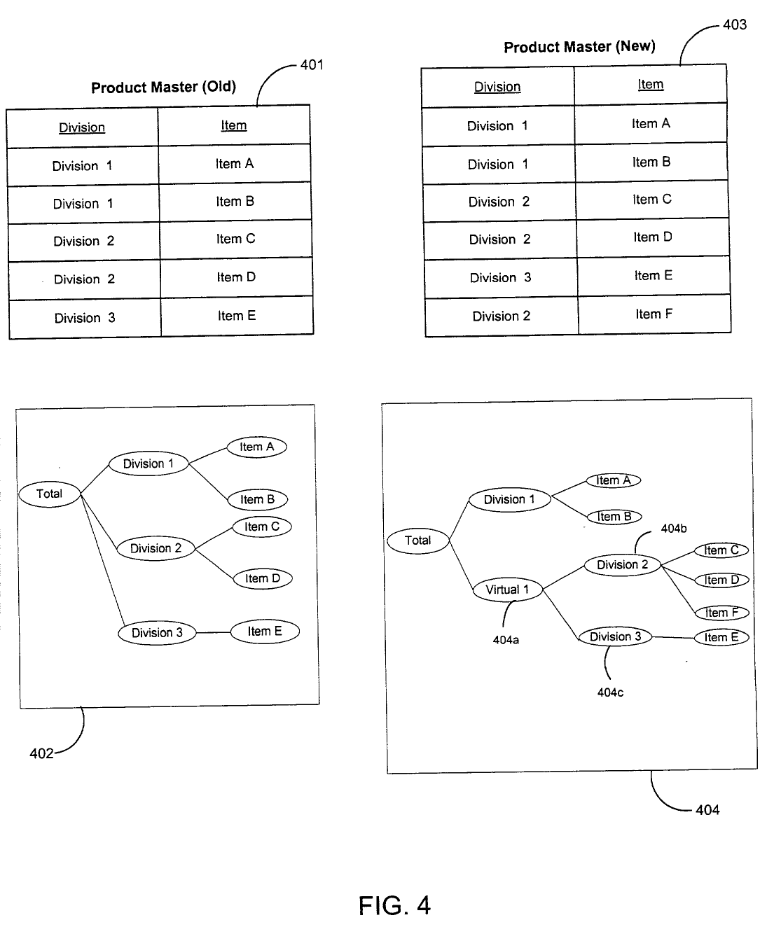

Finally, FIG. 4 is a block diagram illustrating the use of a virtual member to modify a hierarchical tree structure. A tree 402 shows a hierarchical tree structure created based on data in a table 401. A table 403 is identical to the table 401 except for the fact that a new item, Item F, is added to Division 2. In response, the tree 402 is updated to create a tree 404. As illustrated, the tree 404 uses a virtual member 404a and make Division 2 404b and Division 3 404c children of the virtual member 404a. The metadata management system may be programmed so that this change in the level of Division 2 404b and Division 3 404c would not affect technical information and/or business models that refer to them.

It will be apparent to those skilled in the art that various modifications and variations can be made in the system and method for using metadata to flexibly analyze data of the present invention without departing from the spirit or scope of the invention. Thus, it is intended that the present invention cover the modifications and variations of this invention provided they come within the scope of the appended claims and their equivalents.

What is claimed is:

1. A system for using a metadata to flexibly analyze data stored in a plurality of source databases comprising:
the metadata containing technical information and business model information and existing independently of schemata of the plurality of source databases and a plurality of destination databases; and
a metadata management system comprising (1) a mapping means capable of mapping schemata of the plurality of source databases to dimensions and measures in the metadata based on the technical information, (2) a modeling means capable of manipulating the business model information, and (3) a loading means capable of loading the data stored in the plurality of source databases into the plurality of destination databases for analyses based on the technical information and the business model information stored in the metadata.

2. The system according to claim 1, wherein the metadata management system further comprises a destination database management means capable of periodically updating the plurality of destination databases.

3. The system according to claim 1, wherein the plurality of source databases includes a relational database, a flat file, a spreadsheet, and a file created by a third-party application.

4. The system according to claim 1, wherein the plurality of destination databases includes a relational database and a multi-dimensional database.

5. The system according to claim 1, wherein the plurality of source databases is a relational database and the plurality of destination databases is a multi-dimensional database.

6. The system according to claim 1, wherein the modeling means further includes a customization means allowing a user to customize a hierarchical tree structure of dimensions or to modify an existing hierarchical tree structure.

7. The system according to claim 1, wherein the modeling means further includes a ranking means allowing a user to rank one or more dimensions based on their value.

8. The system according to claim 1, wherein the mapping means further includes a time-axis customization means allowing a user to specify a structure of a time axis.

9. The system according to claim 1, wherein the loading means generates one or more programs based on the technical information and the business model information stored in the metadata.

10. The system according to claim 1, wherein the loading means uses one or more programs.

11. The system according to claim 1, wherein the metadata management system further comprises an aggregation means capable of automatically aggregating the data loaded into the plurality of destination databases based on the technical information and the business model information in the metadata.

12. A method of flexibly analyzing data in a plurality of source databases by using a metadata comprising the steps of:
maintaining the metadata, wherein the metadata includes technical information and business model information and exists independently of schemata of the plurality of source databases and of a plurality of destination databases;
mapping the schemata of the plurality of source databases to dimensions and measures in the metadata based on the technical information stored in the metadata;
manipulating the business model information stored in the metadata; and
applying the technical information and the business model information stored in the metadata to load data in the plurality of source databases into the plurality of destination databases for analyses.

13. The method according to claim 12, further comprising the step of periodically updating the plurality of destination databases.

14. The method according to claim 12, wherein the plurality of source databases includes a relational database, a flat file, a spreadsheet, and a file created by a third-party application.

15. The method according to claim 12, wherein the plurality of destination databases includes a relational database and a multi-dimensional database.

16. The method according to claim 12, wherein the plurality of source databases is a relational database and the plurality of destination databases is a multi-dimensional database.

17. The method according to claim 12, further comprising the step of constructing a hierarchical tree structure of dimensions in the metadata.

18. The method according to claim 12, further comprising the step of ranking one or more dimensions in the metadata based on their values.

19. The method according to claim 12, further comprising the step of creating a customized time axis.

20. The method according to claim 12, wherein the applying step uses one or more programs generated based on the technical information and the business model information to load the data in the plurality of source databases into the plurality of destination databases for analyses.

21. The method according to claim 12, wherein the applying step uses one or more programs to load the data in the plurality of source databases into the plurality of destination databases for analyses.

22. The method according to claim 12, further comprising the step of aggregating the data loaded into the plurality of destination databases based on the technical information and the business model information in the metadata.

23. An apparatus for executing commands to use a metadata to flexibly analyze data stored in a plurality of source databases, comprising:
a first set of computers, each computer having a data storage device coupled thereto, wherein the plurality of source databases is stored in the data storage device of the first set of computers;
the metadata stored in a second set of computers wherein the metadata includes technical information and business model information and exists independently of schemata of the plurality of source databases and a plurality of destination databases;
a third set of computers, each computer having a data storage device coupled thereto, wherein the plurality of destination databases is stored in the data storage device of the third set of computers; and
a fourth set of computers for use by a user to analyze the data stored in the plurality of source databases using the metadata and a metadata management system, wherein the metadata management system comprises one or more computer programs for mapping the schemata of the plurality of source databases to dimensions and measures in the metadata based on the technical information, manipulating the business model information, and loading the data stored in the plurality of source databases into the plurality of destination databases for analyses based on the technical information and the business model information stored in the metadata,
wherein the first set of computers, the second set of computers, the third set of computers, and the fourth set of computers are interconnected by a network.

24. The apparatus according to claim 23, wherein the first set of computers and the second set of computers are the same.

25. The apparatus according to claim 23, further comprising one or more programs, performed by the second set of computers, for periodically updating the plurality of destination databases.

26. The apparatus according to claim 23, wherein the plurality of source databases includes a relational database, a flat file, a spreadsheet, and a file created by a third-party application.

27. The apparatus according to claim 23, wherein the plurality of destination databases includes a relational database and a multi-dimensional database.

28. The apparatus according to claim 23, wherein the plurality of source databases is a relational database and the plurality of destination databases is a multi-dimensional database.

29. The apparatus according to claim 23, wherein the one or more programs are also capable of constructing a hierarchical tree structure of dimensions in the metadata.

30. The apparatus according to claim 23, wherein the one or more programs are also capable of creating a time axis to be used in analyses of the data.

31. The apparatus according to claim 23, wherein the one or more programs are also capable of ranking dimensions in the metadata according to their values.

32. The apparatus according to claim 23, wherein the metadata management system further includes one or more programs to automatically generate codes based on the technical information and the business model information for loading the data stored in the plurality of source databases into the plurality of destination databases for analyses.

33. The apparatus according to claim 23, wherein the metadata management system further includes one or more programs for loading the data stored in the plurality of source database into the plurality of the destination database for analyses.

34. The apparatus according to claim 23, wherein the metadata management system further comprises one or more programs to aggregate the data loaded into the plurality of destination databases based on the technical information and the business model information in the metadata.

35. An article of manufacture comprising a program storage medium readable by a computer and embodying one or more instructions executable by the computer to perform method steps for executing a command to use a metadata to flexibly analyze data in a plurality of source databases, the method comprising the steps of:
maintaining the metadata, wherein the metadata includes technical information and business model information and exists independently of schemata of the plurality of source databases and of a plurality of destination databases;
mapping the schemata of the plurality of source databases to dimensions and measures in the metadata based on the technical information stored in the metadata;
manipulating the business model information stored in the metadata; and
applying the technical information and the business model information stored in the metadata to load data in the plurality of source databases into the plurality of destination databases for analyses.

36. The article of manufacture according to claim 35, wherein the method further comprises the step of aggregating the data loaded into the plurality of destination databases based on the technical information and the business model information in the metadata.
